(19) United States
(12) Patent Application Publication
(10) Pub. No.: US 2017/0101224 A1
(43) Pub. Date: Apr. 13, 2017

(54) System and method for distributing bags and analyzing sales of items promoted on bags

(71) Applicant: Steve Kohn, Short Hills, NJ (US)

(72) Inventor: Steve Kohn, Short Hills, NJ (US)

(21) Appl. No.: 14/756,783

(22) Filed: Oct. 13, 2015

(51) Int. Cl. B65D 33/00; G06Q 10/08; G06Q 30/02; B65B 61/20

(52) U.S. Cl. CPC B65D 33/004; B65B 61/20; G06Q 10/08; G06Q 30/0276; G06Q 30/0246

(57) ABSTRACT

A system and method for providing information in and on cases of bags, on the bags themselves, and for distributing cases of bags and for tracking the sales movement of products or services promoted on the bags.

### FIELD OF THE INVENTION

The present invention relates to a system and method for providing information in and on cases of bags, on the bags themselves, and for distributing cases of bags and for tracking the sales movement of products or services promoted on the bags.

### BACKGROUND OF THE INVENTION

In the past, retailers, service providers and/or associations (collectively “bag customers”) purchased or received printed or unprinted bags from a wholesaler, distributor, advertiser, and/or third party (collectively “sourcing companies”) or a bag manufacturer to give to their customers to use for purchases. A bag customer would either buy cases of bags at full price or at a promotional price from a sourcing company or a bag manufacturer, either of whom would sometimes provide cases of bags to bag customers at a subsidized cost if the bags featured product or services advertising.

In some cases, retailers would purchase printed bags promoting the name of a chain, cooperative or wholesaler's private label. In some cases, service providers would purchase bags promoting the name of a government agency or hospital. In some cases, associations would purchase bags promoting the name of an association.

In other cases, retailers would advertise their establishment by purchasing printed bags customized with their store logo and contact information (e.g. store name and address).

In still other cases, retailers would purchase printed bags promoting both the name of a chain, cooperative or wholesaler's private label, as well as the name of the retailer's store, store logo and contact information.

In still other cases, retailers would use printed bags provided to them at minimal cost or at no charge by companies advertising products or services.

In all of these cases, measuring the advertising's effectiveness on sales of the product or service proved difficult. The most common way sourcing companies and bag manufacturers could measure the effectiveness of the program was by, for example, examining same store sales of the product before and after the stores used the bags that had product or service advertising.

In addition, no system existed to ensure that every targeted bag customer received a case of bags within a desired date window, or that they even received the case of bags at all. Furthermore, no system existed to encourage the bag customer to keep a case of distributed bags that they may have received but may not have otherwise ordered.

U.S. Patent Publication No. 2009/0198576 relates to a system and method for brand promotion. Embodiments include providing a game, and including a puzzle for the promotion.

U.S. Patent Publication No. 2007/0267319 relates to a plastic bag pad comprising one or more plastic bags including detachable sections wherein the bags are connected to a plastic header. A portion of each bag may be removed from the header by ripping along a perforated line. The detachable section of each bag may include a coupon or sample, and each bag may include an advertisement or name.

U.S. Patent Publication No. 2006/0110719 relates to educational tools and methods for teaching individuals about the enhanced performance characteristics of textile products.

U.S. Patent Publication No. 2005/0006404 relates to a method and apparatus for promoting hand hygiene based on packaging that provides timely access to and use of hand sanitizing fluids. Distribution of the packets is encouraged by the use of lottery and gaming techniques that heighten the opportunity of using a hand sanitizing fluid.

U.S. Pat. No. 5,855,369 relates to equipment and methods for entering and conducting a prize drawing game of chance, some of which do not require a participant to make a purchase to enter. Entry forms are provided which depict and advertise the product that the game promotes and includes spaces for the entrant to write self-identifying information. The entry forms also include a barcode that identifies the product being promoted. The barcode facilitates automated sorting of entry forms, each promoting a different product. The hand written UPC number requirement gives consumers an incentive to seek out, view and handle the product which is the subject of the promotion.

U.S. Patent Publication No. 2009/0049720 relates to a method for conducting marketing/advertising campaign using lunch bags. The method includes determining at least one product or service to be advertised, determining graphic matter placed on at least one face of the lunch bag, placing the graphic matter onto the face of the lunch bag, identifying targeted users of the advertised product or service and providing the lunch bag to targeted users.

### SUMMARY OF THE INVENTION

The present invention relates to a bag marketing program. It is an object of the present invention to print a sourcing company's private label brand logo or other pertinent information on one side of the bag and a sourcing company's product or service or other information on the other side of the bag.

It is an object of the present invention to print the product or services advertising or other information on one or both sides of the bag, without the sourcing company's logo.

It is an object of the present invention to print a phone number, web site URL, links to social media (e.g. hash tag) or QR code on the bag to track effectiveness of the advertisement.

It is an object of the present invention to print a coupon on the bag that is related to the product or services advertising. It is an object of the present invention for the coupon to have a unique bar code that assists in specifically measuring coupon redemption tied to a specific promotion. It is an object of the present invention for the bag manufacturer to attach a coupon to each bag, such as a peel off coupon. It is an object of the present invention to print a unique bar code on each peel-off coupon that assists in specifically measuring coupon redemption tied to a specific promotion.

It is an object of the present invention to place graphic matter or information on at least one side of the bag. It is an object of the present invention to identify targeted users of the advertised product or service and deliver the bags to bag customers who can provide the bags to the targeted users.

It is an object of the present invention for the information that is placed on at least one side of the bag to comprise providing a game, puzzle or contest relating to the advertised product or service or company marketing the advertised product or service.

It is an object of the present invention when printing on both sides of the bag, for the bag manufacturer to move the seam of the bag to a corner of the bag so that it doesn't interfere with printing on either side of the bag.

It is an object of the present invention to insert marketing collateral in each case of bags that educates the bag customer about the product or service advertised on the bag. It is an object of the present invention to prepare an accompanying letter that is inserted in the case of bags. It is an object of the present invention for the sourcing company or bag manufacturer to determine the content of the collateral or letter that is inserted into the case of bags. It is an object of the present invention to obtain the sourcing company's approval for the marketing collateral and/or letter before the bag manufacturer inserts either in the case.

It is an object of the present invention for the bag customer or bag manufacturer to insert a coupon in each bag.

It is an object of the present invention for the bag manufacturer to insert coupons in each case of bags; for example, to insert 1,000 coupons in a case of 1,000 bags. It is an object of the present invention for the bag customer to distribute coupons to the targeted user by inserting a coupon in a bag before giving a bag to a targeted user. It is an object of the present invention for the bag customer to staple or otherwise attach a coupon to each bag before giving a bag to a targeted user. It is an object of the present invention for the bag customer to individually hand out coupons to the targeted user. It is an object of the present invention for the bag customer to make coupons available to the targeted user so the targeted user can take coupons (e.g. from a pile on a shelf or countertop) himself or herself.

It is an object of the present invention to package the bags together in a case.

It is an object of the present invention to place a sticker on the outside of each case explaining the free nature of the case of bags. The sticker might simply say “Free Case of Bags” or the sticker might explain that the case of bags comes courtesy of the sourcing company. Putting the sticker on the case of bags encourages the bag customer to keep the case of bags, even though the bag customer may or may not have ordered the bags.

It is an object of the present invention for the bag manufacturer to place a sticker on the outside of each case explaining what else the case of bags contains other than the bags. For example, the sticker might say “Valuable Coupons Enclosed” or “Important Marketing Material enclosed”.

It is an object of the present invention not to include a return address on the case label to make it more difficult for the bag customer to return a case of bags that they did not order. This technique assures maximum distribution of the cases of bags and reduces potential case returns.

It is an object of the present invention for the bag manufacturer to affix a separate mailing label to the outside of each case of bags and to mail each case of bags directly to the bag customer. This way, the sourcing company does not have to receive the cases of bags into inventory before re-distributing the cases of bags.

It is an object of the present invention for the bag manufacturer to affix a product description label to the outside of each case, detailing specifics such as item number, product description, case pack, bag size and case bar code.

It is an object of the present invention for the sourcing company to provide a targeted mailing distribution list of bag customers to the bag manufacturer.

It is an object of the present invention for the sourcing company to build a targeted mailing distribution list of bag customers, summarize that list by distribution center or destination point, and provide that list to the bag manufacturer.

It is an object of the present invention for the targeted list of bag customers to be based on promotional or sales objectives established for a particular product or service. For example, if the sourcing company wants to reach diabetic patients who use glucometers to measure their blood sugar levels, the sourcing company may include on the targeted distribution list bag customers who sell or promote diabetes products.

It is an object of the present invention for bag customers who do not want bags with advertising to pay a higher or different price for a case of bags than those bag customers who do accept advertising on the bags.

It is an object of the present invention for the advertising to relate to what the sourcing company is focused on selling. It is an object of the present invention for the advertising to relate to where the bag customer is located. It is an object of the present invention for the advertising to change often (e.g. weekly or monthly).

It is an object of the present invention to tie advertising to specific seasons or times of the year. For example, advertise cough and cold products on a bag that has a Fall design.

It is an object of the present invention for the bags to be distributed to a veterinarian's office. For example, the information on the bag can pertain to prevention of cruelty to animals.

It is an object of the present invention for the bags to be distributed to a physician's office. For example, the information on the bag can pertain to immunizations.

It is an object of the present invention for the bags to be distributed to a hospital. For example, the information on the bag to pertain to sleep disorder, maternity wards, or cancer clinics.

It is an object of the present invention to tie advertising to specific disease states. For example, advertise glucometers on a bag promoting Diabetes Awareness.

It is an object of the present invention for the bag manufacturer, sourcing company, or bag customer to donate a portion of the bag case sales to charitable organizations or associations. For example, the bag manufacturer could make a donation to support research to find a cure for different disease states, or to fund a home for rescue animals. It is an object of the present invention for the bag manufacturer to print messaging on the bag that states who (i.e. the sourcing company, bag customer or bag manufacturer) made such a donation.

The seasonal and awareness bags and other types of bags with advertising may or may not have coupons associated with the bags.

It is an object of the present invention for the bag manufacturer to print messaging on the bag to raise awareness levels of different causes and the charitable organizations or associations that support those causes.

It is an object of the present invention to conduct a marketing/advertising campaign using a bag that is distributed to bag customers comprising: placing information and/or coupons on the bag for at least one product or service to be advertised.

It is an object of the present invention for the bag manufacturer to ship cases of bags directly to the sourcing company so that each can then re-distribute the cases of bags directly to the bag customer.

It is an object of the present invention for the bag manufacturer to ship cases of bags directly to the bag customer.

It is an object of the present invention for a coupon redemption clearinghouse or sourcing company to process the coupons submitted by the bag customer.

The present invention relates to a system for a bag marketing program. With regards to the system of the present invention, information is input into the system with regards to a sourcing company's private label brand logo or other pertinent information which is to be later placed on and/or in the bag. The system is a computer system/cloud, or similar system and the information is stored in a database. It is an object of the present invention for the system to store the logo or other pertinent information that will be printed on either one or both sides of the bag. It is an object of the present invention for the system to direct the printing on the bag.

It is an object of the present invention for the system to store information that is placed on the either side of the bag to comprise providing a game, puzzle or contest relating to the advertised product or service or company marketing the advertised product or service.

It is an object of the present invention for the system to store marketing collateral from the sourcing company which can be printed out and inserted into each of the cases of bags.

It is an object of the present invention for the system to receive information regarding addresses and other information so that a mailing label can be affixed to the outside of each case of bags and to mail each case of bags directly to the bag customer. It is an object of the present invention for the sourcing company to provide a targeted mailing list to the system. This way, the sourcing company does not have to receive the cases of bags into inventory before re-distributing the cases of bags.

It is an object of the present invention to send the cases of bags directly to the sourcing company for the sourcing company to send the cases of bags out directly to the Bag Customer.

It is an object of the present invention for the system to maintain the mailing list that confirms that the cases were delivered.

It is an object of the present invention for the system to receive information regarding a product description, so that the bag manufacturer can affix a product description label to the outside of each case, detailing specifics such as item number, product description, case pack, bag size and case bar code.

It is an object of the present invention for the system to receive sourcing company approval before providing any marketing collateral or letter in the cases of bags.

It is an object of the present invention for the system to have input in it information regarding the free nature of each case of bags which can then be printed on a sticker and placed on the outside of each case containing the bags.

It is an object of the present invention for the system to store information with regards to a sticker that is placed on the outside of each case explaining what else the case of bags contains other than the bags. For example, the sticker might say “Valuable Coupons Enclosed” or “Important Marketing Material enclosed”.

It is an object of the present invention for the system to be provided or for the system to be able to search the internet or a company's database server so that it downloads a targeted distribution list based on promotional or sales objectives established for a particular product or service.

It is an object of the present invention for the bag manufacturer, sourcing company, or bag customer to donate a portion of the bag case sales to charitable organizations or associations. For example, the bag manufacturer could make a donation to support research to find a cure for different disease states, or to fund a home for rescue animals. It is an object of the present invention for the system to store information for printing a message on the bag that states who (i.e. the sourcing company, bag customer or bag manufacturer) made such a donation.

It is an object of the present invention for the system to store phone numbers, website addresses/URL, links to social media or QR codes which are then placed on the bags to track effectiveness of each advertisement.

It is an object of the present invention for the system to provide or print coupons which are either inserted in a case that contains the bags, or inserted into the bags by the bag manufacturer or bag customer. It is an object of the present invention for the system to provide the information so that coupons are printed directly on the bag, or attach coupons to the bag so that the coupon can be removed off each bag, such as peeling a coupon off the bag.

It is an object of the present invention for each coupon to have a unique barcode placed on it by the system of the present invention that assists in specifically measuring coupon redemption tied to a specific promotion.

It is an object of the present invention for the system to base the advertising on where the bag customer is located, or the type of products or services that the bag customer is offering.

It is an object of the present invention for the system to change the advertising printed on a bag for a specific bag customer on a weekly, monthly or seasonal period.

It is an object of the present invention for the system to calculate which advertisements on the bags are the most successful and to continue presenting those advertisements on the bags in the correct time periods for that success.

It is an object of the present invention for the system to store information regarding how many coupons were distributed, how many were redeemed, where the coupons were redeemed, date of redemption, and what was the total dollar amount of redemption. It is an object of the present invention to compare dollar amount of the redemption with the purchase price of the product or service.

### BRIEF DESCRIPTION OF DRAWINGS

FIG. 1 is a flow chart showing the relationships between the different parties and the bag manufacturer.

FIG. 2 is a flow chart showing the types of information that can be printed on the bag by the bag manufacturer and the process for doing same.

FIG. 3 is a flow chart showing the different objects or documents that may be inserted into a case of printed bags, along with the printed bags themselves and the process for doing same.

FIG. 4 is a flow chart showing what can be added to the outside of a case of printed bags and the process for doing same.

FIG. 5 is a flow chart showing a distribution model and method of the present invention.

FIG. 6 is a flow chart showing how to measure an advertising campaign's effectiveness.

FIG. 7 shows an embodiment of a front view of a bag of the present invention.

FIG. 8 shows an embodiment of a front view of a case of the present invention.

FIG. 9 shows an embodiment of a top view of an open box containing contents within the box of the present invention.

FIG. 10 shows an embodiment of a front view of a bag of the present invention.

### DETAILED DESCRIPTION OF THE INVENTION

The present invention relates to a system and method for providing advertisements or information on bags from sourcing companies. The bags are provided to bag customers. The advertisements or information relate to products or services sold by the bag customer or sold by the sourcing company who advertises on the bag. In a preferred embodiment, the advertisements in the form of coupons can be tracked by a scanner which can then assist the sourcing company in determining the effectiveness of the advertising campaign.

In an embodiment, the sourcing company provides the content of the advertising to the system of the present invention, or the system provides content for the sourcing company from which to choose.

The system of the present invention can divert some or all of the costs of the bags from the bag customer to the sourcing company in exchange for the bag customer's willingness to accept and use bags that feature advertising.

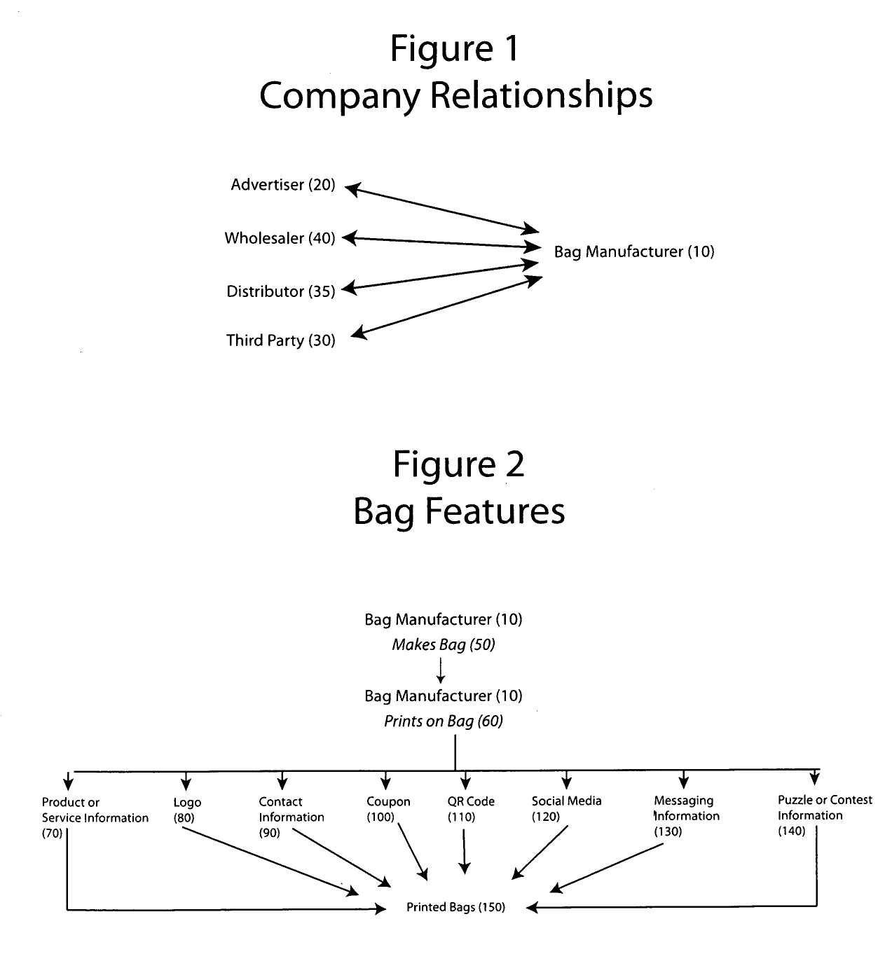

FIG. 1 shows an Advertiser 20, Distributor 35, Wholesaler 40 and/or third party 30 engaged in business discussions with a Bag Manufacturer 10. Either entity can begin discussions with any of the other entities, and have several rounds of back-and-forth discussions before agreeing on deal parameters. The entities can also talk collectively amongst themselves. For example, if the Third Party 30 comes up with an advertising idea, the Third Party 30 can contact the Advertiser 20, who contacts the Wholesaler 40 who contacts the Bag Manufacturer 10. Several rounds of discussions can ensue before the Bag Manufacturer 10 is asked to make the cases of bags. The discussions lead to information being provided to the Bag Manufacturer 10 so that the Bag Manufacturer can print information on the bags for distribution.

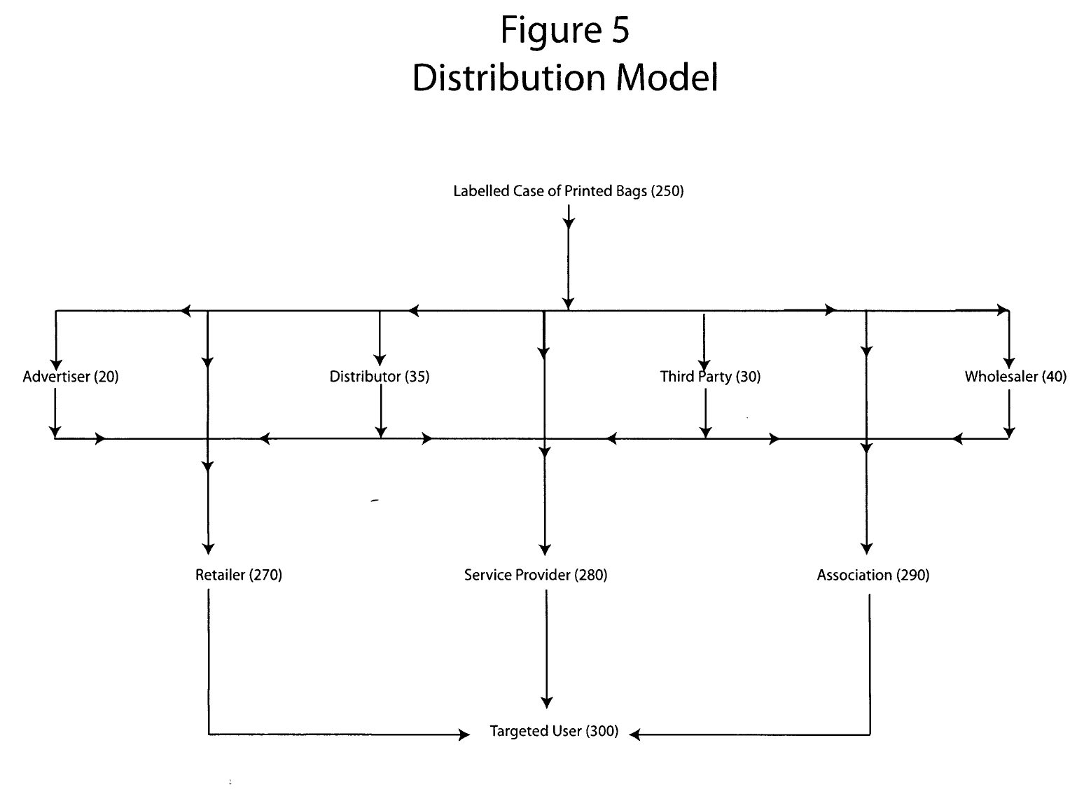

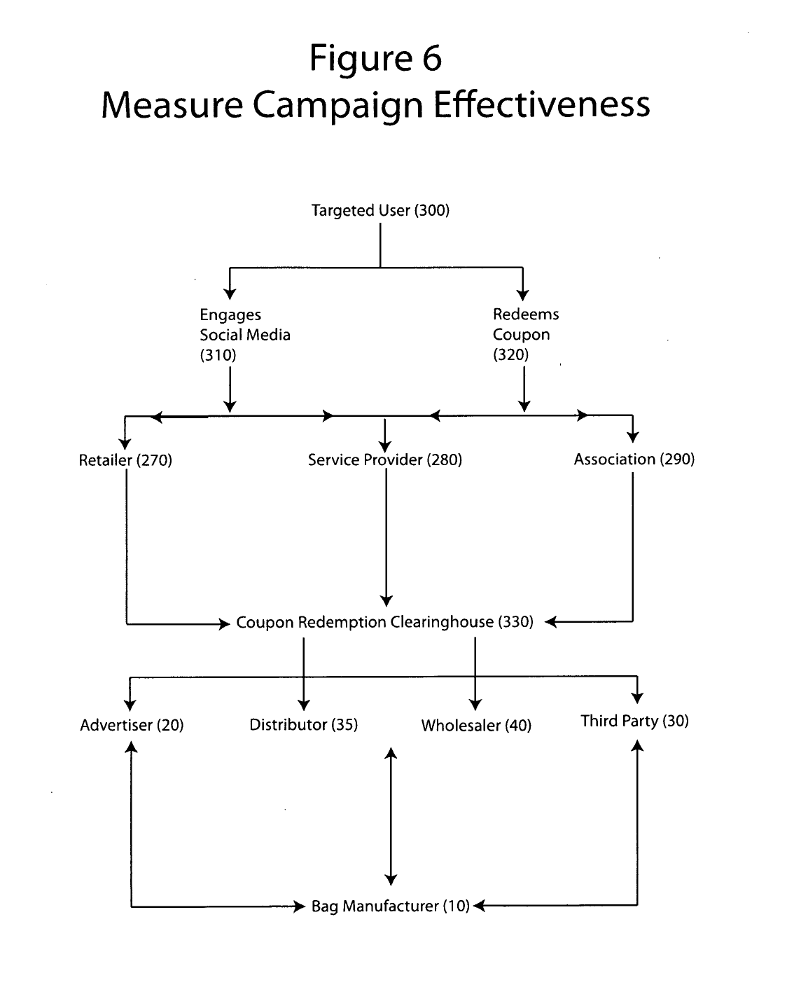

FIG. 2 shows a Bag Manufacturer 10 making bags 50, and the same or different Bag Manufacturer 10 printing on the bags 60 all kinds of information described in FIG. 2, resulting in Printed Bags 150. Product or Service Information 70 may contain details about how the advertised product works or details about the provided service. Logo 80 may depict full product or service artwork or even sponsoring company artwork or bag customer artwork. Contact Information 90 may contain the name of an organization or association, along with that organization's or association's phone number, address, and/or contact person. Coupon 100 may be printed on the bag itself or attached to the bag as a peel-off coupon or by other devices. QR code 110 may provide a link to additional information about the advertised product or service. Social Media 120 may contain a unique hash tag or Facebook page, or link to any other social media web site or service. Messaging Information 130 may contain details about the supported charity or cause, or any other supporting details about the product or service. Puzzle or Contest Information 140 may contain details about a game or contest or even a sweepstakes designed to appeal to the Targeted User 300 (shown in FIG. 5 and FIG. 6).

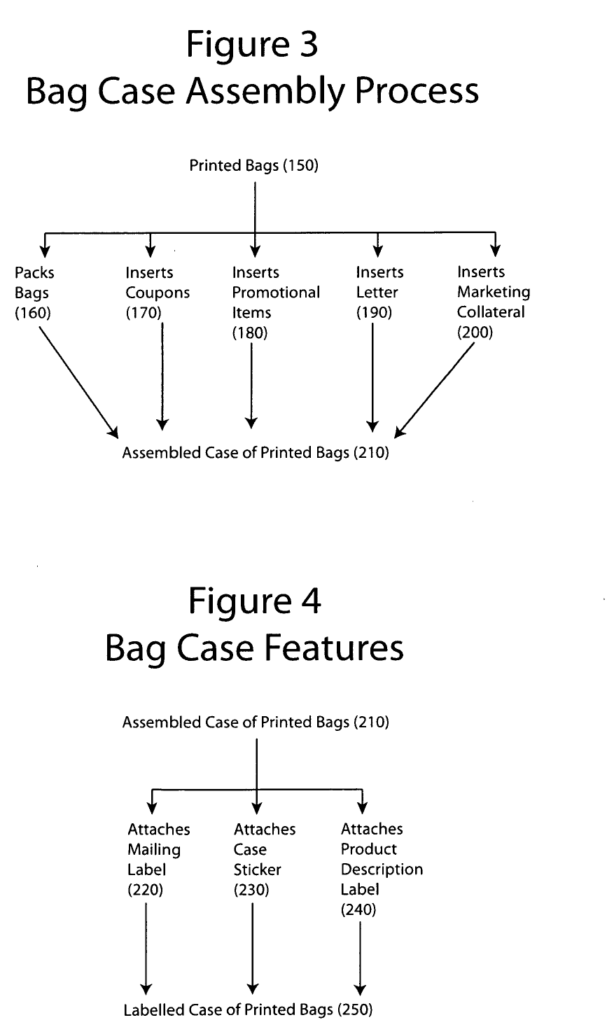

FIG. 3 shows how the Printed Bags 150 end up as an Assembled Case of Printed Bags (210). The bag manufacturer Packs Bags 160 into a case or bundle, and may insert some or all of the following into the case or bundle:
Pre-printed Coupons 170, preferably printed with identifying information such as a bar code
Promotional Items 180 such as pens or pads, or anything else related to the product or service being advertised
Letter 190, that explains the nature of the promotion, and potentially directs the bag customer to distribute Coupons 170 or Promotional Items 180 to the Targeted User 300 (shown in FIG. 5 and FIG. 6)
Marketing Collateral 200 such as a product or service catalog or brochure.

FIG. 4 shows the labels and/or stickers that may be applied to each Assembled Case of Printed Bags 210, resulting in a Labelled Case of Printed Bags 250:
Mailing Label 220 which could be applied if the sourcing company directs the Bag Manufacturer 10 to ship the case of bags directly to the bag customer or to the sourcing company.
Case Sticker 230 that explains what else the case of bags contains other than bags. For example, the sticker might say “Valuable Coupons Enclosed” and/or “Free Case of Bags”.
Product Description Label 240 details specifics such as item number, product description, case pack, bag size and case bar code.

FIG. 5 shows the different paths the Labelled Case of Printed Bags 250 can take to be delivered to the bag customer and ultimately the Targeted User 300. For example, the Bag Manufacturer 10 can ship the cases of bags directly to any or all of the sourcing companies, i.e. Advertiser 20, Wholesaler 40, Distributor 35, or Third Party 30. The sourcing companies can then ship the cases of bags directly to any or all of the bag customers, i.e. Retailer 270, Service Provider 280 or Association 290. Alternatively, the Bag Manufacturer 10 can ship the cases of bags directly to any or all of the bag customers, bypassing the sourcing companies.

FIG. 6 shows what happens after the Targeted User 300 receives a printed bag. The Targeted User 300 can Engage Social Media 310 to, for example, post opinions about the product or service, or even enter a contest or sweepstakes. The Targeted User 300 can also Redeem Coupon 320, and use it to get a promotional discount on the advertised product or service. The Targeted User 300 would present the coupon to one of the bag customers, i.e. Retailer 270, Service Provider 280, or Association 290, who would then send the coupon to a Coupon Redemption Clearinghouse 330 or sourcing company for further processing. The sourcing company, i.e. Advertiser 20, Wholesaler 40, Distributor 35 or Third Party 30, would then analyze the redemption rate, and provide feedback to the Bag Manufacturer 10. The sourcing company and bag customer could confer with one another, and with the Bag Manufacturer 10, to determine what changes to make to the next promotional advertising campaign.

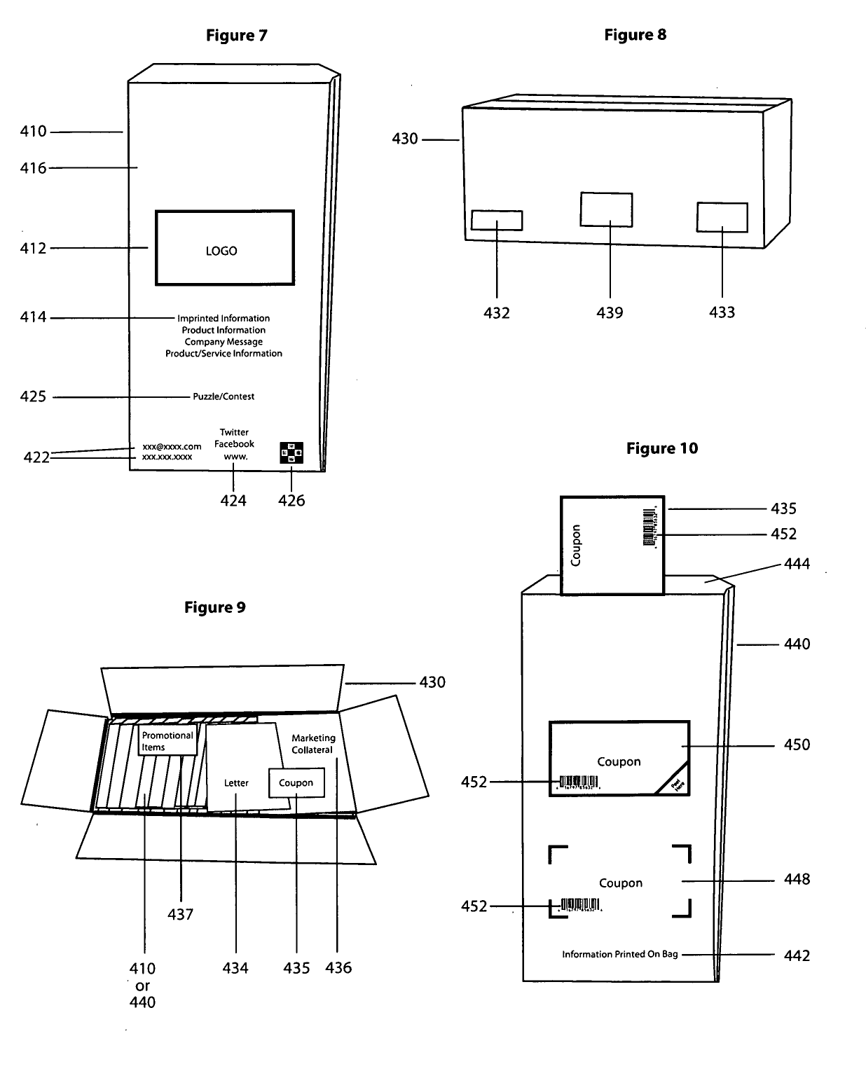

FIG. 7 shows a bag 410 having a logo 412 and printed information 414 printed on a side 416 of the bag 410. Puzzle or contest information 425 can also be printed on the bag 410. FIG. 7 further shows a phone number or email address 422 printed on the bag 410, a website 424 printed on the bag 410 and/or a QR code 426 printed on the bag 410. Each of 422, 424, or 426 assists in tracking the effectiveness of the advertisement.

FIG. 8 shows a case 430 which has a sticker 432 that is placed on the outside of case 430 that explains for example, the free nature of the case of bags or the valuable coupons enclosed. Label 433 is a mailing label on case 430. Label 439 is the product description label on case 430 for the contents of the case.

FIG. 9 shows a case 430 which contains bags 410 or 440. In an embodiment, a letter 434 is inserted into the case 430. Marketing collateral 436 and coupons 435 are placed in the case 430. The coupons 435 can be handed out or put in bags 410 or 440 by the Bag Customer at point of purchase. Case 430 may further contain promotional items 437.

FIG. 10 shows a bag 440 having information 442 printed on the bag 440. Bag 440 also has an opening 444. Coupons 435 may be placed inside bag 440. Coupons 448 may be part of bag 440 and can be ripped off. Coupon 450 may be affixed to bag 440, and can be peeled off. Coupon 435, 448 and 450 may have a unique bar code 452 that assists in specifically measuring coupon redemption tied to a specific promotion.

1. A bag comprising:
a sourcing company's private label brand logo and/or other pertinent information from said sourcing company printed on at least one side of said bag;
said bag packaged with multiple other bags in a case of bags;
said bags having printed on it a phone number, web site URL, links to social media and/or QR code to track effectiveness of advertisement on said bag;
said bag provided to a bag customer.

2. The bag of claim 1 further comprising coupons printed on said bag, inserted in said bag or attached to said bag related to product or services that are advertised.

3. The bag of claim 1 further comprising printed information regarding an advertiser's product or service on other side of said bag.

4. The bag of claim 1 wherein marketing collateral is inserted into each of said case of bags that educates said bag customer about any products advertised on said bag.

5. The bag of claim 1 wherein an accompanying letter is inserted into said case of bags.

6. The bag of claim 1 wherein a sticker is placed on outside of each of said case explaining free nature of said case of bags, and/or that said case contains valuable coupons.

7. The bag of claim 2 wherein said coupons attached to said bags are peeled off said bag.

8. The bag of claim 2 wherein said coupons have a unique bar code that specifically measures coupon redemption tied to a specific promotion.

9. The bag of claim 1 wherein said pertinent information relates to what said bag customer is focused on selling or where said bag customer is located.

10. The bag of claim 9 wherein said pertinent information on said bag changes weekly, monthly or seasonally.

11. The bag of claim 1 wherein said information placed on said bag is a game, puzzle or contest relating to said advertised product or service or company marketing said advertised product or service.

12. The bag of claim 10 wherein said pertinent information relates to cold and cough products on a bag with a fall design.

13. The bag of claim 9 wherein the pertinent information relates to glucometers on a bag promoting Diabetes awareness.

14. The bag of claim 9 wherein the pertinent information is women's health products on a bag promoting breast cancer awareness.

15. The bag of claim 1 wherein when printing on both sides of said bag, seam of said bag is moved to a corner so it does not interfere with printing on either side of said bag.

16. The bag of claim 1 wherein information on said bag comprises product or service information, a logo, contact information, a coupon, QR code, social media, messaging information, puzzle or contest information, or any combination thereof.

17. A method for conducting a marketing/advertising campaign using a bag comprising:
providing information on said bag from a sourcing company to a bag manufacturer;
providing from said sourcing company to said bag manufacturer a targeted mailing distribution list based on promotional or sales objectives for a particular product or service;
providing said bags to bag customers chosen by said sourcing company;
providing identifiers on said bag or coupon for tracking purchases of related products;
placing said bags in cases to be shipped.

18. The method of claim 17 further comprising:
placing coupons in said bag or attached to said bag or part of said bag from said sourcing company for at least one product or service advertised on said bag.

19. The method of claim 17 wherein said information comprises a game, puzzle or contest relating to a product or service provided by said sourcing company.

20. The method of claim 17 wherein said bag manufacturer ships said cases of bags directly to said sourcing company so said sourcing company can distribute directly to said bag customer.

21. The method of claim 17 wherein said bag manufacturer ships said cases of bags directly to said bag customer.

22. The method of claim 17 wherein said bag manufacturer confirms said cases are delivered.

23. The method of claim 17 wherein said bag manufacturer delivers said cases of bags within a desired date window requested by said sourcing company.

24. The method of claim 17 wherein marketing collateral, a letter, coupons, promotional material or any combination thereof are placed in said cases.

25. The method of claim 17 wherein said bag manufacturer or sourcing company donates a portion of bag case sales to a charity and message is printed on said bag giving credit to said bag customer for making donation.

26. The method of claim 17 wherein said bag customer who do not want said bags with advertising pay a higher price or different price for said bags while those who accept advertising on said bags pay a discounted price.

27. A system for distributing bags with printed information to bag customers at a discounted price comprising:
information is inputted into said system with regards to source company's private label brand logo or other pertinent information which is later placed on said bag;
said system is a computer system and said information is stored in database;
said system assists in printing said logo or said other pertinent information on either one or both sides of said bag;
said system stores phone numbers, website addresses, links to social media or QR codes which are then placed on said bags to track effectiveness of each advertisement;
said system is provided information which it stores for later placement on cases in which said bags are placed;
said system assists in providing said cases of bags to bag customers or sourcing company.

28. The system of claim 27 further comprising storing marketing collateral from said sourcing company which is then printed out and inserted into said case carrying said bags.

29. The system of claim 27 wherein said system requires said sourcing company's approval before providing said marketing collateral or other information in said case with said bags.

30. The system of claim 27 wherein said system receives information regarding free nature of each case of bags or about valuable nature of materials in said case which is then printed on a sticker and placed on outside of each case containing said bags.

31. The system of claim 27 wherein said system is either provided or said system searches internet so that it downloads a targeted distribution list based on promotional or sales objectives established for a particular product or service, which said system uses to later distribute said bags.

32. The system of claim 27 wherein said system prints coupons or are provided with coupons which are inserted into each bag or provided to said consumer by other ways, printed directly on said bag, or attached to said bag so that said coupon is removed from each bag.

33. The system of claim 32 wherein each coupon has a unique barcode placed on it by said system that assists in specifically measuring coupon redemption tied to a specific promotion.

34. The system of claim 27 wherein said system bases its advertising on where said bag customer is located, or the type of products that said bag customer is selling.

35. The system of claim 27 wherein said system changes said advertising printed on said bag for a specific bag customer on a weekly, monthly or seasonal period.

36. The system of claim 27 wherein said system calculates which advertisements on said bags are most successful and continues presenting those advertisements on said bags in correct time periods for that success.

37. The system of claim 27 wherein said system provides advertisements on said bags from said sourcing company;
said bags provided to said bag customer;
said advertisements related to products or services sold by said bag customer.

38. The system of claim 27 wherein said sourcing company provides content of advertising to system, or said system provides content for said source company from which to choose.

39. The system of claim 27 wherein said system lowers cost of said bags to said bag customer by offering acceptance of advertising on said bags which diverts costs of said bags to said source company.

40. The system of claim 27 wherein no return address label is placed on said case.

41. The system of claim 27 wherein said system confirms that said cases of bags were received by said bag customer or said sourcing company.

42. The system of claim 27 wherein said system confirms that said cases of bags were received within a desired date window established by said sourcing company.
